(19) United States
(12) Patent Application Publication
(10) Pub. No.: US 2007/0025451 A1
(43) Pub. Date: Feb. 1, 2007

(54) Transmission trace structure

(75) Inventor: Darin James Douma, Monrovia, CA (US)

Correspondence Address: NORTH WEBER & BAUGH LLP, 2479 E. BAYSHORE ROAD, SUITE 707, PALO ALTO, CA, 94303, US

(73) Assignee: Finisar Corporation

(21) Appl. No.: 11/180,226

(22) Filed: Jul. 13, 2005

(51) Int. Cl. H04L 25/00

(52) U.S. Cl. 375/257

(57) ABSTRACT

System and methods are disclosed for creating and using a trace structure. System and methods are disclosed for creating and using low impedance differential trace structures. A trace structures comprises at least two substantially collinear traces electrically connected along the length of the traces by at least one connection. The trace structures may be readily manufactured using cost-effective manufacturing techniques and tolerances.

### BACKGROUND OF THE INVENTION

Advancements in technology have led to the design and development of increasingly higher speed communications devices that operate at low power levels. At high data rates, interconnects, including short interconnects, should be treated as a transmission line. As power levels drop and the data rates increase, the effects of the transmission lines in the circuitry becomes increasingly more significant.

For example, certain systems may require impedance matching of the transmissions lines. Matching the impedance may be achieved in a number of ways, depending on the particular circuit configurations, but generally involve the addition of resistive components, such as resistors. The addition of a resistive element or elements, although beneficial for impedance matching, may have the negative effect of reducing the efficiency of the circuit because power is being dissipated across the resistor. The heat generated as power is dissipated by these resistive elements may also cause problems to temperature-sensitive circuit components.

One way to address these problems is to reduce the impedance of transmission lines, thereby allowing more power to be dissipated by an attached load rather than being dissipated by the transmission line and any impedance matching elements. The impedance of a transmission line is, in part, a function of its circuit design and, in part, a function of the physical characteristics of the transmission line. One type of transmission line is a microstrip. A microstrip typically consists of a transmission line or trace placed in close proximity to a ground plane or trace. The impedance of the microstrip is, in part, a function of the width of the transmission line and its distance from the ground plane. A transmission line's impedance may be reduced by creating a wider transmission line and/or placing it closer to the ground plane. Problems arise, however, when trying to manufacture low impedance microstrips. Manufacturing processes are limited in their ability to control feature tolerances. If the manufacturing tolerance limits are too large, the resulting variation in semiconductor structures may be too excessive for designs that require low impedance. Furthermore, there are limits on how much a trace, or microstrip, design can be changed because, for example, an excessively wide trace may consume too much space on a printed circuit board (“PCB”). Accordingly, current manufacturing processes cannot, with reasonable cost-effectiveness, produce low impedance transmission lines.

### SUMMARY OF THE INVENTION

The present invention is directed to methods and systems for making a transmission trace structure. The present invention is also directed to methods and systems for transmitting a signal on a trace structure or structures.

According to one aspect of the present invention, a transmission trace structure comprises at least two substantially collinear traces electrically connected along the length of the traces by at least one connection. The trace structure is intended to have the same signal transmitted on the collinear traces. In an alternate embodiment, a second trace structure may be positioned substantially parallel to and adjacent to the first trace structure to allow coupling between the first and second trace structures when signals are transmitted on the first and second trace structures.

According to another aspect of the present invention, the transmission system may be used to transmit a signal or signals. In one embodiment, a first signal is transmitted on a first trace structure and a second signal is transmitted on a second trace structure. The first and second trace structures each comprise at least two substantially collinear traces electrically connected along the length of the traces by at least one connection. In an embodiment, the first and second signals are odd-mode, or differential, signaling.

Although the features and advantages of the invention are generally described in this summary section and the following detailed description section in the context of embodiments, it shall be understood that the scope of the invention should not be limited to these particular embodiments. Many additional features and advantages will be apparent to one of ordinary skill in the art in view of the drawings, specification, and claims hereof.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a cross-sectional view of two transmission lines forming a differential pair.

FIG. 2 is a cross-sectional view of an embodiment of the present invention.

FIG. 3 is a top view of an embodiment of the present invention.

FIG. 4A-C depicts alternate embodiments of collinear traces.

FIG. 5 is an embodiment of a method for producing an embodiment of a low impedance trace structure.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. One skilled in the art will recognize that embodiments of the present invention, described below, may be performed in a variety of ways and using a variety of means. Accordingly, the embodiments described below are illustrative of specific embodiments of the invention and are meant to avoid obscuring the invention.

Reference in the specification to “one embodiment” or “an embodiment” means that a particular feature, structure, characteristic, or function described in connection with the embodiment is included in at least one embodiment of the invention. The appearance of the phrase“in one embodiment,” “in an embodiment,” or the like in various places in the specification are not necessarily all referring to the same embodiment.

High-speed electronic systems often use differential signaling. Differential signaling structures may consist of two microstrips or traces that are driven by single-ended signals which are exactly out of phase. If the two traces are located close together and share the same or very similar properties, certain benefits can be achieved through the use of differential signaling. For example, the differential signal is less affected by noise. Since the differential signal is the difference between the two transmitted signals, noise components common to both transmission lines are subtracted out of the differential signal.

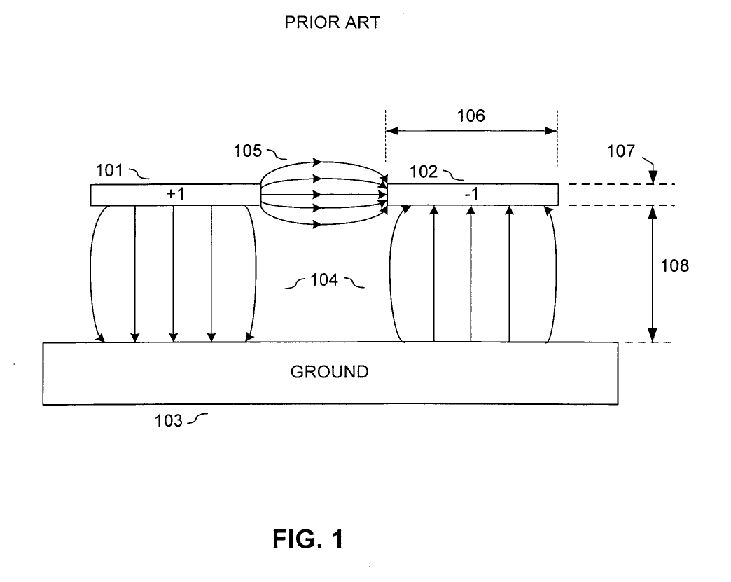

FIG. 1 depicts an implementation of differential, or odd-mode, signaling transmission lines. Trace 101 and trace 102 receive signals which are exactly out of phase (represented by +1 and −1). Traces 101 and 102 are located above a ground plane 103. The impedance of this system depends upon a number of factors. Factors that affect the impedance of the system are coupling between traces 101 and 102 and between traces 101 and 120 and ground plane 103. FIG. 1 depicts electric field lines 105, which represent the coupling between trace 101 and trace 102, and also depicts electric field lines 104, which represent the coupling between traces 101, 102 and ground plane 103.

The impedance of transmission lines may be changed by changing, among other factors, the width 106 of the trace, the thickness 107 of the trace, and the distance 108 the trace is from the ground plane 103. Impedance decreases as the trace width 106 increases, as the thickness 107 increases, or as the distance 108 to the ground plane 103 decreases. To reduce impedance, a trace may be made wider and positioned closer to the ground plane. However, there are manufacturing limits to these feature characteristics.

To build sufficiently low impedance systems using cost-effective manufacturing tolerances becomes extremely difficult. To achieve low impedance, the trace width 106 becomes unreasonably large and the distance 108 between the traces and the ground plane must become extremely small. Such a system is not a cost-effective design for a number of reasons. Space on a printed circuit board is limited. As the trace widths increase, the space on the printed circuit board becomes even more of a premium. Certain designs, particularly those circuit designs containing a large number of traces in a small package, may not fit within the necessary space constraints. Furthermore, as the nominal dimension for the distance 108 between the traces and the ground plane decreases, manufacturing tolerances result in extremely variant systems. Consider, for example, if the distance 108 between the traces and the ground plane is designed to be 0.010 inches and the manufacturing tolerance is ±0.001 inch, the distance 108 may vary by 20%. As that distance decreases, to help reduce the impedance, the percentage variations become increasingly larger. If the distance 108 is designed to be 0.005 inches but the manufacturing tolerance remains at ±0.001 inch; the variation is 40%, which may not be acceptable.

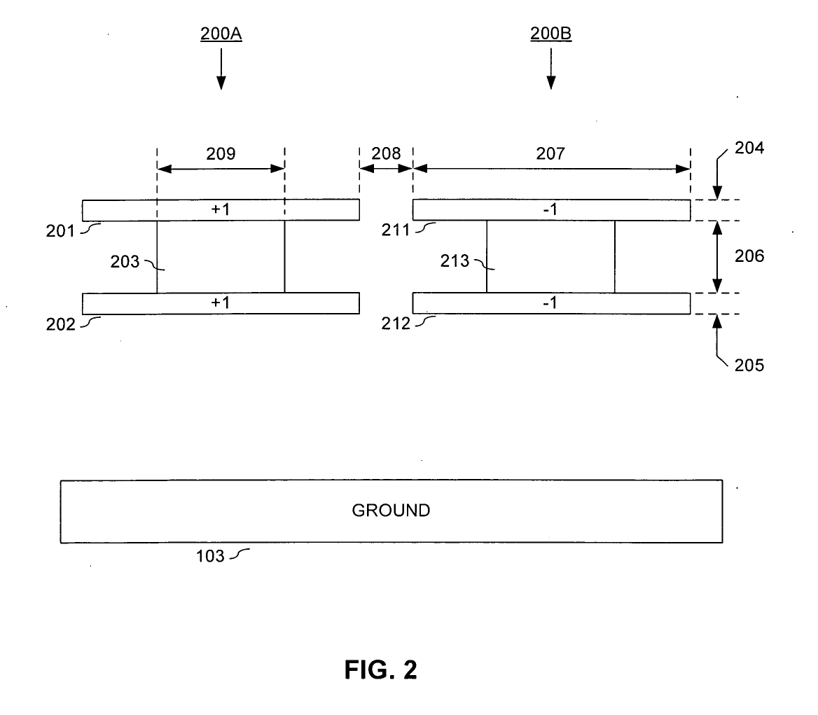

The present invention increases the coupling between differential traces to reduce the impedance without requiring extremely expensive manufacturing tolerances or techniques. FIG. 2 depicts a trace or microstrip 201 collinear with a second trace 202. Trace 201 and 202 may be electrically connected along the length of the traces by one or more connections 203. A second set of traces 211 and 212 are similarly configured and are similarly connected along the length of the traces with one or more connections 213. In an embodiment, the electrical connection may be formed by one or more vias.

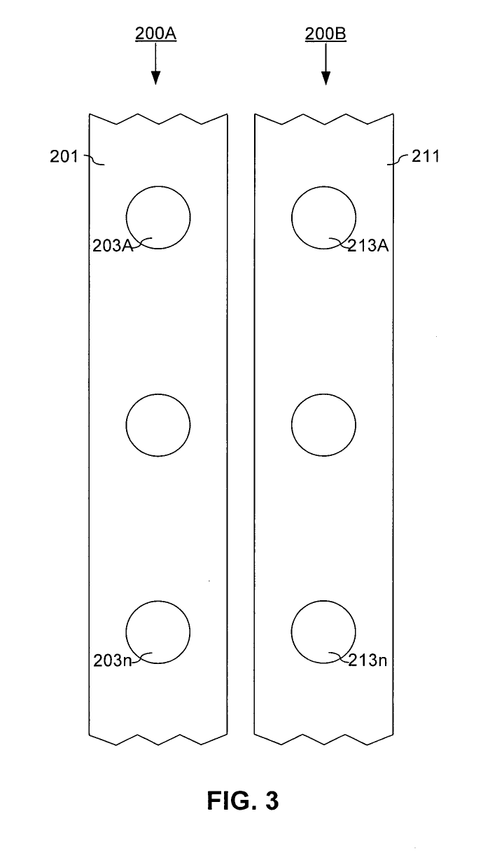

FIG. 3 depicts a top view of the trace structures 200A and 200B according to one embodiment. FIG. 3 illustrates trace 201 electrically connected to trace 202 (not shown in FIG. 3), and trace 211 electrically connected to trace 212 (not shown in FIG. 3). In the illustrated embodiment, trace 201 is connected to trace 202 by vias 203 and trace 211 is connected to trace 212 by vias 213. FIG. 3 depicts a number of vias 203A-n and 213A-n along the length of the traces. The connections 203, 213 may occur at regular intervals or may occur intermittently. It should be noted that the connections 203 and 213 do not necessarily need to occur at the center of the trace but may be offset. It should also be noted that the size and/or position of connections 203, 213 may vary.

The number of connections 203, 213 may also vary. In one embodiment, a single connection 203, 213 may connect the upper and lower traces. In another embodiment, two connections 203, 213 at the near and far ends of the traces may connect the upper and lower traces. Alternatively, the upper and lower traces may be electrically connected along their length by a number of connections. The number of electrical connections may depend upon the amount of coupling between the upper and lower traces that may occur as the signal diverges as it propagates along the traces. Some factors that may affect signal divergence include the frequency of the signal and the length of the traces.

Connected traces 201 and 202 create a trace structure 200A and connected traces 211 and 212 create another trace structure 200B, each with a much larger effective thickness. The added thickness promotes more coupling between the adjacent trace structures. As the coupling between the trace structures 200A and 200B increases, the trace structures couple less with the ground plane 103. The impedance of the system, in odd-mode signaling, is reduced and the necessity of controlling the distance to the ground plane 103 is also reduced. Because the traces 201, 202, 211, and 212 do not require extremely tight PCB manufacturing tolerances and also because the distance between the ground plate and the trace structures 200A and 200B is less critical, the present invention may be manufactured using cost-effective manufacturing systems and tolerances. For example, the present invention may be employed to produce low impedance trace structures on conventional FR4-type printed circuit boards using typical manufacturing tolerances, yet achieve greater control of the impedance.

One skilled in the art will recognize that impedance of a system may be altered by adjusting one or more of the dimensions, design, or material composition of the traces or dielectric. For example, as noted previously, the impedance may be reduced by increasing the width 207 or thickness 204, 205 of the traces. Also, the distance 208 between the two trace structures 200A, 200B may be adjusted to reduce the impedance. As the trace structures 200A, 200B are positioned closer together, they couple more with each other and less with the ground plane 103. Although FIG. 2 illustrates an embodiment with only two collinear traces electrically connected along their length, other embodiments may include connecting three or more collinear traces. Accordingly, the design may include creating trace structures that are comprised of more than two traces electrically connected together.

By way of example, a microstrip system designed for a 10 gigahertz system may be manufactured with 0.026 inch trace widths 207 that are 0.001-0.002 inches thick 204, 205. The traces may be connected with vias that are 0.012 inches in diameter 209 and 0.007 inches in height 206. The trace structures 200A, 200B may be position 0.005 inches apart 208. The resulting system can produce approximately 25 ohms and lower impedance. Because these values are readily manufactured using commodity component manufacturing techniques, the design is cost effective. Furthermore, since the impedance of the system is much less dependant on maintaining very small dimension, such as, for example, maintaining a very small distance between the trace structures 200A, 200B and the ground plane 103, the resulting system is more robust. It must be noted that the dimensions and values in the foregoing example are provided by way of illustration only and shall not limit the present invention in any way, including limiting the present invention to those ranges or ratios.

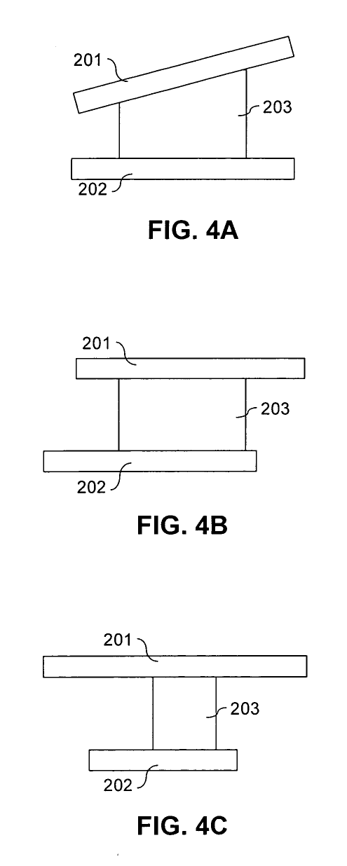

FIG. 4A-C depict embodiments of various trace structures which may be considered collinear. FIG. 4A illustrates that the traces 201, 202 may not be parallel. FIGS. 4B and 4C illustrate that the traces 201, 202 may be offset, of different widths, or both. One skilled in the art will recognize that other structures and variants fall within the scope of the present invention.

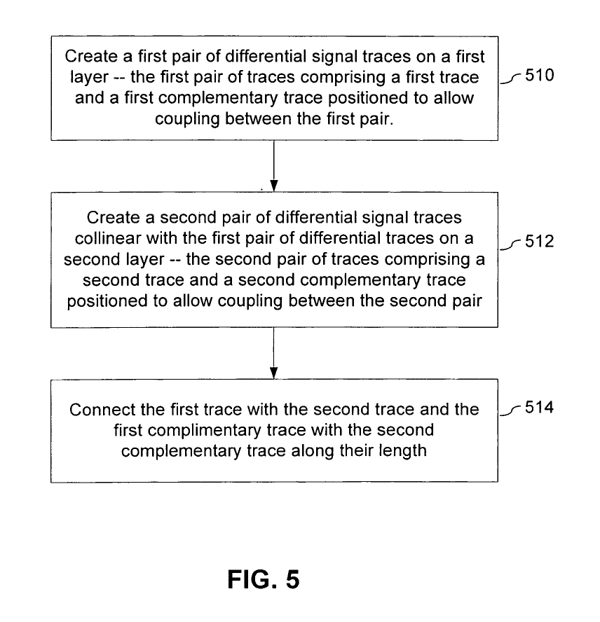

FIG. 5 depicts an embodiment of a method for making a differential trace structure. A first pair of differential signal traces is created 510 on a first layer. The first pair of traces is comprised of a first trace and a first complementary trace. For example, an embodiment of first trace 202 and first complementary trace 212 are depicted in FIG. 2. The first trace and the first complementary trace are positioned sufficiently close to allow coupling between them. A second pair of differential signal traces collinear with the first pair of differential signal traces is created 512 on a second layer. The second pair of traces is comprised of a second trace and a second complementary trace. For example, an embodiment of second trace 201 and second complementary trace 211 are depicted in FIG. 2. The second trace and the second complementary trace are also positioned sufficiently close to allow coupling between them. The first trace is electrically connected 514 with the second trace and the first complimentary trace is electrically connected 514 with the second complementary trace. The connected traces create a pair of low impedance differential trace structures. The trace structures possess an increased ability to couple together.

One skilled in the art will recognize that one aspect of the present invention is that it produces lower odd-mode impedance and higher even-mode impedance. This result may be very useful in many applications. For example, the present invention may be employed whenever efficiency is significant. Applications that have power constraints or emission constraints also benefit from application of the present invention. Specific examples include, but are not limited to, transmission lines or connections related to communication systems, such as radio transmitters or communication lasers.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the scope of the appended claims.

I claim:

1. A transmission system comprising a first trace structure comprising at least two substantially collinear traces electrically connected along the length of the traces by at least one connection wherein the same signal is transmitted on the collinear traces.

2. The transmission system of claim 1 further comprising a second trace structure positioned substantially parallel to and adjacent to the first trace structure to allow coupling between the first and second trace structures when signals are transmitted on the first and second trace structures, said second set of traces comprising at least two substantially collinear traces electrically connected along the length of the traces by at least one connection.

3. The transmission system of claim 2 wherein the at least one electrical connection of the first trace structure and the at least one electrical connection of the second trace structure are vias.

4. The apparatus of claim 2 wherein at least one of the first and second trace structures further comprises at least one additional trace substantially collinear with the at least two substantially collinear traces and is electrically connected along the length of the trace to the trace structure by at least one connection.

5. The transmission system of claim 2 wherein the at least two substantially collinear traces of the first trace structure are electrically connected along the length of the traces by a plurality of connections and the at least two substantially collinear traces of the second trace structure are electrically connected along the length of the traces by a plurality of connections.

6. The transmission system of claim 5 wherein the first and second trace structures are on a printed circuit board.

7. The transmission system of claim 6 wherein the plurality of connections of the first trace structure and the plurality of connections of the second trace structure are vias.

8. The transmission system of claim 2 wherein the first and second trace structures can be used for differential signaling.

9. An apparatus for providing transmission trace structures comprising:
a first trace structure comprising at least two substantially collinear traces electrically connected along the length of the traces by at least one connection; and
a second trace structure positioned substantially parallel to and adjacent to the first trace structure to allow coupling between the first and second trace structures when signals are transmitted on the first and second trace structures, said second set of traces comprising at least two substantially collinear traces electrically connected along the length of the traces by at least one connection.

10. The apparatus of claim 9 wherein at least one of the first and second trace structures further comprises at least one additional trace substantially collinear with the at least two substantially collinear traces and is electrically connected along the length of the trace to the trace structure by at least one connection.

11. The apparatus of claim 9 wherein the first and second trace structures are on a printed circuit board.

12. The apparatus of claim 11 wherein the at least one connection of the first and second trace structures are vias.

13. The apparatus of claim 9 wherein the first and second trace structures can be used for differential signaling.

14. A method for making trace structures comprising the steps of:
creating a first pair of traces on a first layer, said first pair of traces comprising a first trace and a first complementary trace positioned adjacent to each other to allow coupling between them when signals are transmitted on the traces;
creating a second pair of traces substantially collinear with the first pair of traces on a second layer, said second pair of traces comprising a second trace and a second complementary trace positioned adjacent to each other to allow coupling between them when signals are transmitted along the traces;
connecting the first trace with the second trace along the length of the traces by at least one electrical connection; and
connecting the first complimentary trace with the second complementary trace along the length of the traces by at least one electrical connection.

15. The method of claim 14 wherein the at least one electrical connection of the first and second trace structures are vias.

16. The method of claim 14 wherein the first and second trace structures are created on a printed circuit board.

17. A method for transmitting signals comprising the steps of:
transmitting a first signal on a first trace structure, said first trace structure comprising at least two substantially collinear traces electrically connected along the length of the traces by at least one connection; and
transmitting a second signal on a second trace structure, said second trace structure positioned substantially parallel to and adjacent to the first trace structure to allow coupling between the first and second trace structures when the first and second signals are transmitted on the first and second trace structures, said second set of traces comprising at least two substantially collinear traces electrically connected along the length of the traces by at least one connection.

18. The method of claim 17 wherein the first and second trace structures are on a printed circuit board.

19. The method of claim 18 wherein the at least one connection of the first and second trace structures are vias.

20. The method of claim 17 wherein the first signal and the second signal can create a differential signal.
